(19) United States
(12) Patent Application Publication
(10) Pub. No.: US 2024/0162452 A1
(43) Pub. Date: May 16, 2024

(54) Layered Manganese Oxide, and Preparation Method Thereof

(71) Applicant: OSAKA UNIVERSITY, Osaka (JP)

(72) Inventors: Yu Katayama, Osaka (JP); Ryutaro Ono, Yamaguchi (JP); Asuka Morinaga, Osaka (JP); Tomoya Higo, Osaka (JP); Shunsaku Uchiyama, Yamaguchi (JP)

(21) Appl. No.: 18/548,359

(22) PCT Filed: Mar. 14, 2022
(86) PCT No.: PCT/JP2022/011337

§ 371 Date: Aug. 30, 2023

(30) Foreign Application Priority Data
Mar. 12, 2021 (JP) 2021-040510
Mar. 3, 2022 (JP) 2022-032921

(51) Int. Cl. H01M 4/90; C25B 1/21

(52) U.S. Cl. CPC H01M 4/9016; C25B 1/21

(57) ABSTRACT

It is an object of the present invention to provide a catalyst having high catalytic activity for oxygen reduction reaction, hydrogen evolution reaction, and the like, particularly a catalyst employing platinum group particles having a small particle diameter. A layered manganese oxide comprising platinum group metal particles between layers. A method for producing a layered manganese oxide comprising platinum group metal particles between layers, or platinum group metal particles, the method comprising introducing a platinum group complex between layers of a layered manganese oxide and reducing the introduced platinum group complex by electrolysis, wherein a potential applied to the platinum group complex is changed in a positive direction and a negative direction.

### TECHNICAL FIELD

The present invention relates to a layered manganese oxide comprising platinum group particles between layers, and an electrode comprising the layered manganese oxide on the surface, and a method for producing the layered manganese oxide and platinum group particles.

### BACKGROUND ART

In recent years, fuel cells that are power generation devices having a small environmental load have attracted attention. Oxygen reduction reaction (ORR) that is the reaction on their cathode side is a complicated reaction involving four electrons, and therefore the reaction rate is slow. Platinum shows the highest ORR activity but is a precious metal, and its high cost is a barrier to widespread use. Hydrogen gas attracts attention as a next-generation energy carrier such as a fuel for fuel cells. Particularly, hydrogen evolution reaction (HER) that can produce hydrogen from water holds the key to the large scale widespread use of hydrogen gas. Platinum shows excellent HER activity but is not put to large scale practical use because of its high cost. Under such circumstances, with material development grounded on the conventional bulk electronic state, performance improvement is reaching a ceiling, and new catalyst designs are necessary. Accordingly, the development of subnano or single-atom metal catalysts is studied with the aim of improving the activity of fuel cell reactions and the utilization efficiency of catalysts, because when a metal is made subnano or a single atom, the energy state of the surface changes, and the catalytic activity improves (see non-patent document 1 and non-patent document 2). But a plurality of steps comprising heat treatment are necessary for synthesis, and therefore the synthesis procedure is cumbersome, and in addition, it is necessary to support the metal catalyst by subjecting a carbon material to special treatment in order to prevent aggregation during the synthesis. Therefore, it is required to produce subnano or single-atom metal catalysts, particularly platinum group catalysts such as platinum having high catalytic activity, by a simple method.

On the other hand, manganese dioxide (MnO₂) is inexpensive and rich in the amount of resources. As is found from the actual result that manganese dioxide has been used as battery materials for many years, manganese dioxide is safe and has a small environmental load. Therefore, manganese dioxide has been developed as the positive electrode active materials of secondary batteries, various catalysts, and supports for catalysts. For example, a material in which organic quaternary ammonium ions are introduced between the layers of a layered manganese oxide (see patent document 1), and a material in which cobalt ions are introduced between layers as an aquo complex are proposed (see non-patent document 3). However, ions are introduced between layers, and platinum or the like is not introduced as a metal.

### PRIOR ART DOCUMENTS

### Patent Documents

Patent Document 1: Japanese unexamined Patent Application Publication No. 2006-76865

### Non-Patent Documents

Non-patent Document 1: Botao Qiao, Aiqin Wang, Xiaofeng Yang, Lawrence F. Allard, ZhengJiang, Yitao Cui, Jingyue Liu, Jun Li, and Tao Zhang, Nature Chemistry, 3, 634-641, (2011).
Non-patent Document 2: Yuanjun Chen, Shufang Ji, Chen Chen, Qing Peng, Dingsheng Wang, Yadong Li, Joule, 2, 1242-1264 (2018).
Non-patent Document 3: Kotaro Fujimoto, Takuya Okada, and Masaharu Nakayama*J. Phys. Chem. C 2018, 122, 8406-8413

### SUMMARY OF THE INVENTION

### Object to be Solved by the Invention

It is an object of the present invention to provide a catalyst having high catalytic activity for oxygen reduction reaction, hydrogen evolution reaction, and the like, particularly a catalyst employing platinum group particles having a small particle diameter.

### Means to Solve the Object

The present inventors have started the study of catalysts showing excellent activity for oxygen reduction reaction and hydrogen evolution reaction. The present inventors have paid attention to subnano or single-atom platinum group catalysts in the course of the study and advanced the development of a method for producing subnano or single-atom platinum group catalysts, and found out that by utilizing the gap between the layers of a layered manganese oxide, subnano or single-atom particles of platinum, palladium, or the like can be fabricated without complicated steps while aggregation is suppressed. The platinum particles or the palladium particles obtained between the layers of the layered manganese oxide are present as a metal rather than as cations and have excellent activity as a catalyst for oxygen reduction reaction and hydrogen evolution reaction. Further, the layered manganese oxide has both continuous oxide layers for electron transfer and continuous spaces for ion transfer, and therefore the layered manganese oxide itself serves as an excellent support for platinum or the like, and a layered manganese oxide comprising platinum group particles between layers can be used as a catalyst.

That is, the present invention is specified by the matters shown below.

(1) A layered manganese oxide comprising platinum group metal particles between layers.

(2) The layered manganese oxide according to the above (1), wherein a particle diameter of the platinum group metal particles is an atomic diameter of the platinum group to 0.7 nm.

(3) The layered manganese oxide according to the above (2), wherein the particle diameter of the platinum group metal particles is a particle diameter obtained by subtracting, from an interlayer distance of the layered manganese oxide obtained by X-ray diffraction measurement, 0.45 nm, which is a crystallographic thickness of a layer included in the interlayer distance.

(4) The layered manganese oxide according to the above (1), wherein a size of a gap between a layer and a layer in the layered manganese oxide is an atomic diameter of a platinum group to 1 nm.

(5) An electrode comprising the layered manganese oxide according to any one of the above (1) to (4) on a surface.

(6) A method for producing a layered manganese oxide comprising platinum group metal particles between layers, or platinum group metal particles, the method comprising introducing a platinum group complex between layers of a layered manganese oxide and reducing the introduced platinum group complex by electrolysis, wherein a potential applied to the platinum group complex is changed in a positive direction and a negative direction.

(7) The method according to the above (6), comprising forming, on a surface of an electrode, a layered manganese oxide in which a platinum group complex is introduced between layers, wherein a potential of the electrode is changed in a positive direction and a negative direction.

The present invention can also be specified by the matters shown below.

(i) A layered manganese oxide comprising platinum group particles between layers.

(ii) The layered manganese oxide of the above (i), wherein a particle diameter of the platinum group particles is an atomic diameter of the platinum group to 5 nm.

(iii) An electrode comprising the layered manganese oxide of the above (i) or (ii) on a surface.

(iv) A method for producing a layered manganese oxide comprising platinum group particles between layers, or platinum group particles, the method comprising introducing a platinum group complex between layers of a layered manganese oxide and reducing the introduced platinum group complex by electrolysis, wherein a potential applied to the platinum group complex is changed in a positive direction and a negative direction.

(v) The method of the above (iv), comprising forming, on a surface of an electrode, a layered manganese oxide in which a platinum group complex is introduced between layers, wherein a potential of the electrode is changed in a positive direction and a negative direction.

### Effect of the Invention

The present invention can provide platinum group particles of nanosize or less, particularly single-atom size or subnanosize, and can provide the platinum group particles in a state of being supported between the layers of a layered manganese oxide. The platinum group particle and a layered manganese oxide comprising the platinum group particles between layers are excellent in catalytic activity for oxygen reduction reaction, hydrogen evolution reaction, and the like.

### BRIEF DESCRIPTION OF DRAWINGS

FIG. 1 is a diagram showing X-ray diffraction peaks in Example 1.

FIG. 2 is a diagram showing XPS spectra in Example 1.

FIG. 3 is a diagram showing XPS spectra in Example 1.

FIG. 4 is a diagram showing XPS spectra in Example 1.

FIG. 5 is a diagram showing X-ray diffraction peaks in Example 3.

FIG. 6 is a diagram showing XPS spectra in Example 3.

FIG. 7 is a diagram showing XPS spectra in Example 3.

FIG. 8 is a diagram showing XPS spectra in Example 3.

FIG. 9 is a diagram showing XPS spectra in Examples 4 to 6.

FIG. 10 is a diagram showing X-ray diffraction peaks in Examples 4 to 6.

FIG. 11 is a diagram showing X-ray diffraction peaks in Examples 7 to 10.

FIG. 12 is a diagram showing the results of the CV of deposits obtained in Example 1.

FIG. 13 is a diagram showing the results of the CV of a platinum electrode.

FIG. 14 is a diagram showing the results of the CV of the deposit 3 (2) obtained in Example 2.

FIG. 15 is a diagram showing the results of the CV of deposits obtained in Example 3.

FIG. 16 is a diagram showing the results of the CV of a Pd electrode.

FIG. 17 is a diagram showing the results of the CV of a deposit obtained in Comparative Example 1.

FIG. 18 is a diagram showing the results of the CV of a deposit obtained in Comparative Example 2.

FIG. 19 is a diagram showing the results of the LSV of a deposit obtained in Example 1.

FIG. 20 is a diagram showing the results of the LSV of a platinum electrode.

FIG. 21 is a diagram showing the results of the LSV of the deposit obtained in Example 1 and the LSV of the platinum electrode.

FIG. 22 is a diagram showing the results of the LSV of the deposit 3 obtained in Example 1, a GC electrode, and a platinum electrode.

FIG. 23 is a diagram showing the results (HER activity) of the LSV of the deposits 3 obtained in Examples 4 to 6.

FIG. 24 is a diagram showing the results (ORR activity) of the LSV of the deposits 3 obtained in Examples 4 to 6.

### MODE OF CARRYING OUT THE INVENTION

The layered manganese oxide of the present invention is a layered manganese oxide comprising platinum group particles between layers. The layered manganese oxide in the present invention is not particularly limited as long as layers of manganese oxide are formed, and there are gaps between the layers. Examples of the layered manganese oxide in the present invention can include a birnessite type layered manganese oxide. The birnessite type layered manganese oxide is a layered compound in which octahedron structures represented by MnO₆ in which manganese is at the center and six oxygens are arranged at the vertices share the vertices and the edges with each other and form an expanded layer, and the layers are stacked, and the birnessite type layered manganese oxide is a manganese oxide possessing a Mn³⁺/Mn⁴⁺ mixed valence (MnO₂). The birnessite type layered manganese oxide is also referred to as γ-MnO₂ because of the crystal structure. The “between layers” in the present invention means a gap between layers. The size of the gap between layers in the layered manganese oxide of the present invention depends on the size of the platinum group particles included between the layers. When the platinum group particles are single atoms, the size of the gap is on the order of the atomic diameter of each platinum group. When several platinum group particles of single atoms overlap or when the particle diameter of the platinum group particles is subnanosize (1 nm or less), the size of the gap is on the order of the atomic diameter to 1 nm. When there are many overlaps of platinum group particles of single atoms or when the particle diameter of the platinum group particles is nanosize, the size of the gap is 1 nm or more. The platinum group refers to ruthenium (Ru), rhodium (Rh), palladium (Pd), osmium (Os), iridium (Ir), and platinum (Pt), and these atoms have substantially equivalent sizes (atomic diameters). For example, the atomic diameter of platinum is 0.278 nm, and the atomic diameter of palladium is 0.274 nm. However, from the viewpoint of maintaining the layered structure, the size of the gap is preferably 5 nm or less, more preferably 3 nm or less. In the present invention, particles of single atoms refer to particles of the size of one atom, that is, substantially the same size as the atomic diameter. In the description of this application, an interlayer distance refers to a value obtained by adding the thickness of one layer and the size of the gap between the layer and the next layer, and the size of the gap can be obtained by excluding the thickness of one layer from the interlayer distance. The interlayer distance can be obtained from the results of X-ray diffraction measurement. As the thickness of one layer, the crystallographic thickness calculated from the crystal structure can be used. In the case of the birnessite type layered manganese oxide, octahedron structures represented by MnO₆ in which manganese is at the center and six oxygens are arranged at the vertices share the vertices and the edges with each other and expand planarly to form one layer. Therefore, the octahedron is placed on a flat surface with one of the faces down, and the distance between the face (lower face) in contact with the flat surface and the face (upper face) parallel to this face (lower face) is computed assuming that the manganese atoms and the oxygen atoms are spheres possessing respective atomic diameters, and the computed value is the crystallographic thickness and can be used as the thickness of one layer. As this value, 0.45 nm can be used. In the present invention, platinum group particles of the size of the gap or less are included between the layers of the layered manganese oxide in a dispersed state without aggregation, or in an aggregated state, or in a state in which particles dispersed without aggregation and aggregated particles are present.

The particle diameter of the platinum group particles in the layered manganese oxide of the present invention is not particularly limited as long as it is a size at which the platinum group particles can be present between the layers without causing the peeling of the layers of the layered manganese oxide. Therefore, examples of the particle diameter of the platinum group particles can include the range of the atomic diameter of each atom of the platinum group to 5 nm. The layered manganese oxide of the present invention has both continuous oxide layers for electron migration and continuous spaces (gap between layers) for ion transfer and comprises platinum group particles having a small particle diameter between the layers and therefore has excellent activity as a catalyst for hydrogen evolution reaction, oxygen reduction reaction, and the like. From the viewpoint of improving the catalytic activity, the particle diameter of the platinum group particles is preferably in the range of the atomic diameter of each platinum group to 5 nm, more preferably in the range of the atomic diameter of each platinum group to 1 nm, and further preferably in the range of the atomic diameter of each platinum group to 0.7 nm. The particle diameter of the platinum group particles can be obtained from observation by an electron microscope or the measurement of the interlayer distance of the layered manganese oxide by X-ray diffraction. The platinum group particles in the present invention are present between the layers of the manganese oxide as a platinum group metal rather than as platinum group ions. Therefore, the platinum group particles in the present invention are platinum group metal particles. However, platinum group ions may be included in a range that does not inhibit the catalytic activity. The content of the platinum group particles in the layered manganese oxide of the present invention is not particularly limited as long as it is in a range where use as a catalyst is possible. Examples of the content of the platinum group particles can include 0.05 to 80% by mass, 2 to 70% by mass, and 5 to 60% by mass based on the manganese oxide (comprising no platinum group). In the present invention, by forming or adhering on an electrode substrate a catalyst layer of a layered manganese oxide comprising platinum group particles between layers, it can be employed as an electrode used in various batteries such as fuel cells, and the like. The electrode substrate is not particularly limited as long as it can be used as an electrode. Examples of the electrode substrate can include a metal plate of platinum or the like, and a carbon material such as carbon paper, carbon cloth, and graphite.

The method for producing the layered manganese oxide of the present invention is not particularly limited, and the layered manganese oxide of the present invention can be produced by a method comprising introducing a platinum group complex between the layers of a layered manganese oxide and electrochemically reducing the platinum group complex by electrolysis. The method for producing the layered manganese oxide into which the platinum group complex is to be introduced, and the type and the like of the layered manganese oxide are not particularly limited, and, for example, the layered manganese oxide can be obtained by electrochemically oxidizing a divalent manganese compound in the presence of quaternary ammonium ions. The organic group of the quaternary ammonium should be selected according to the interlayer distance of the target manganese oxide. When the layer spacing is widened, a long chain or branched alkyl group, an aromatic group, a macromolecule such as a cationic polymer, or the like can be selected. When the layer spacing is decreased, a quaternary ammonium having a small molecular weight such as tetramethylammonium can be selected. Examples of the quaternary ammonium can include tetramethylammonium, tetraethylammonium, tetrapropylammonium, tetrabutylammonium, and polydiallyldimethylammonium. A compound such as a hydroxide, chloride, nitrate, or sulfate thereof can be dissolved in an electrolytic solution and used. Examples of the compound can include tetramethylammonium chloride, tetraethylammonium bromide, tetrabutylammonium chloride, trimethyldodecylammonium chloride, trimethylaniline chloride, and dimethyl ditertiary butylammonium chloride. The divalent manganese compound is not particularly limited as long as it is a divalent manganese compound soluble in an electrolytic solution. Examples of the divalent manganese compound can include a salt of an inorganic acid, for example, manganese sulfate, manganese chloride, manganese nitrate, and manganese carbonate and can also include an organomanganese compound such as manganese ammonium oxalate and manganese potassium oxalate. By dissolving a divalent manganese compound and a quaternary ammonium in an electrolytic solution and anodizing the divalent manganese ions in the coexistence of the quaternary ammonium ions by electrochemical means, a layered manganese oxide can be deposited on an electrode substrate.

The platinum group complex to be introduced between the layers of the layered manganese oxide in the present invention is not particularly limited as long as it is a complex of a size at which it can be introduced between the layers of the layered manganese oxide, and is cationic. The ligand constituting the platinum group complex may be a monodentate ligand, a bidentate ligand, or a tri- or higher dentate ligand. Examples of the ligand can include aqua (H₂O), ammine (NH₃), chloride (Cl⁻), cyanide (CN⁻), hydroxide (OH⁻), thiocyanato (SCN⁻), carbonato (CO₃²⁻), nitrito (NO₂⁻), oxalato (C₂O₄²), carbonyl (CO), nitrosyl (NO), ethylenediamine, acetylacetonato, 2,2′-dipyridyl, and 1,10-phenanthroline. Examples of complexes of these ligands and the platinum group can include a tetraammineplatinum complex, a dinitrodiammineplatinum complex, chloroplatinic (IV) acid hexahydrate, a bis(acetylacetonato)platinum complex, and a dichloro(η4-1,5-cyclooctadiene)platinum complex in the case of platinum. Also in the case of other platinum groups such as ruthenium, rhodium, palladium, and iridium, examples of the complexes can include complexes with the above ligands as in the case of platinum, for example, a hexaammineruthenium complex, a hexaamminerhodium complex, a chloropentaamminerhodium complex, a tetraamminepalladium complex, and a hexaammineiridium complex. The method for introducing the platinum group complex between the layers of the layered manganese oxide is not particularly limited, and, for example, the platinum group complex can be introduced by ion exchange with the cations present between the layers of the manganese oxide before the introduction of the platinum group complex. When quaternary ammonium ions are present between the layers of the manganese oxide, the platinum group complex can be introduced by ion exchange with the quaternary ammonium ions. Examples of the method of ion exchange can include a method of immersing the layered manganese oxide in an aqueous solution in which a compound that produces a cation of the platinum group complex upon dissolution in water is dissolved. Examples of the compound can include tetraammineplatinum(II) chloride, a dinitrodiammineplatinum complex, a bis(acetylacetonato)platinum complex, and a dichloro(η4-1,5-cyclooctadiene)platinum complex in the case of platinum. Also in the case of other platinum groups, a compound can be selected as in the case of platinum, for example, hexaammineruthenium(III) chloride, hexaamminerhodium(III) chloride, chloropentaamminerhodium(III) chloride, tetraamminepalladium(II) chloride, hexaammineiridium(III) hydroxide, or hexaammineiridium(III) chloride.

Examples of the method of reducing the platinum group complex introduced between the layers of the manganese oxide, by electrolysis to form the platinum group can include a method involving changing the potential applied to the platinum group complex in the positive direction and the negative direction, and can include a method of immersing an electrode (working electrode) in which the manganese oxide in which the platinum group complex is introduced between the layers is formed on the surface, and a counter electrode in an electrolytic solution, and setting the working electrode at the potential at which the reduction of the platinum group complex occurs. Preferably, the potential of the working electrode should be changed in the positive direction and the negative direction to change the potential of the working electrode between the potential at which reduction occurs and the potential at which oxidation occurs. Specifically, the potential of the working electrode can be swept in the negative direction and then swept in the positive direction. Alternatively, the potential of the working electrode can be swept in the positive direction and then swept in the negative direction. The range of the swept potential is not particularly limited, and examples thereof can include the range of −1.5 to 1.5 V, −1.5 to 1.0 V, −1.3 to 1.0 V, −1.3 to 0.7 V, and −1.0 to 0.6 V versus a silver-silver chloride electrode. It is preferred that when metalation is efficiently completed, the lower limit of the potential swept versus the silver-silver chloride electrode is set at on the order of −1.0 V or less, and when metalation is stably performed, the range of the swept potential is set at on the order of −1.3 V or more and 0.6 V or less. Examples of the sweep rate can include 1 to 200 mV/s. When one reciprocation between the lower limit and upper limit of the potential is one cycle, the number of cycles can be determined according to the particle diameter of the platinum group required. From the viewpoint of obtaining platinum group particles of subnanosize or single-atom size, the number of cycles is preferably larger, and examples thereof can include the number of times such as 10 to 150 times and can include the number of times such as 100 to 8000 times. It is thought that by changing the potential between the reducing side and the oxidizing side, the reduction of the platinum group complex occurs gradually, and therefore platinum group particles having a small particle diameter such as subnanosize or single-atom size are generated. The range of the swept potential may be changed midway. For example, it is possible to start the sweep in a narrow range and widen the range gradually or stepwise, or the widened range may be narrowed. The range of the swept potential (potential difference) may be constant, and examples of the range can include 3 V, 2 V, and 1.7 V. In the production method of the present invention, by adjusting the electrochemical conditions such as the sweep rate, the number of cycles, and the range of the swept potential (potential difference), the particle diameter of the generated platinum group particles can be adjusted. According to the production method of the present invention, the platinum group particles are produced in a narrow region, that is, between the layers of the layered manganese oxide, and therefore platinum group particles having a small particle diameter can be produced while aggregation is suppressed. Further, by changing the potential in electrolyzing the platinum group complex, platinum group particles having an extremely small particle diameter such as subnanosize or single-atom size can be produced. The produced platinum group particles are supported between the layers of the layered manganese oxide from the point in time of production, and therefore no effort to support the platinum group particles anew on another supporting body is needed, and the layered manganese oxide comprising the platinum group particles between the layers, itself can be used as a catalyst. Therefore, the production method of the present invention is also a method for producing a layered manganese oxide comprising platinum group particles between layers, as well as being a method for producing platinum group particles. The platinum group particles in the present invention has high catalytic activity compared with conventional platinum group catalysts, and therefore a catalytic effect similar to those of the conventional ones can be achieved in a smaller amount than the conventional ones, and as a result, the amount of the platinum group used can be lessened. The layered manganese oxide produced by the production method of the present invention may be peeled from the electrode and used, but can also be used as the electrode as it is, and a catalyst electrode can be formed without needing an effort such as coating an electrode anew with a catalyst. The electrode substrate of the working electrode used in the production method of the present invention is not particularly limited as long as it is an electrode used in electrolysis. Examples of the electrode substrate can include a metal plate of platinum or the like, and a carbon material such as carbon paper, carbon cloth, and graphite. Examples of the counter electrode can include platinum, porous carbon, gold, and titanium.

### EXAMPLES

The present invention will be specifically described below by giving Examples of the present invention, but the technical scope of the present invention is not limited to these illustrations.

### Example 1

A layered manganese oxide of the present invention was fabricated by the following steps 1 to 3.

(Step 1) 0.7089 g of 50 mM [CH₃(CH₂)₃]₄NCl (TBACl) and 0.024 g of 2 mM MnSO₄·5H₂O were dissolved in distilled water to 50 mL. The obtained aqueous solution was bubbled with N₂ for 20 min to remove the oxygen in the solution. Electrochemical deposition was performed under the conditions of keeping 1.0 V, and 200 mC/cm², employing a salt bridge, with the reference electrode being Ag/AgCl, the counter electrode being a Pt mesh, and the working electrode being a glassy carbon rotating disk electrode (GC electrode) having a diameter of 5 mm ground with polishing diamond and alumina, to deposit a deposit on the GC electrode. The deposit after the step 1 is a deposit 1.

(Step 2) After the deposit on the GC electrode obtained in the step 1 was lightly washed with distilled water without being separated from the GC electrode, the deposit on the GC electrode was vacuum-dried at ordinary temperature for 1 h. After drying, the GC electrode in a state in which the deposit adhered was immersed in a 50 mM Pt(NH₃)₄Cl₂ solution for 24 h to perform ion exchange. The deposit after the step 2 (after the ion exchange) is a deposit 2.

(Step 3) A three-electrode cell employing for the working electrode the GC electrode in the state in which the deposit adhered obtained in the step 2, a Pt wire for the counter electrode, and Ag/AgCl for the reference electrode was constructed. For the electrolytic solution, 0.1 M KOH in which N₂ was bubbled for 20 min was employed. A potential sweep was started using a potentiostat connected to the cell, with the potential of the working electrode set at −0.975 to 0.050 V (vs Ag/AgCl). At this time, the potential sweep start potential was set at −0.974 V (vs Ag/AgCl). With the sweep rate set at 50 mV/s, gradually the potential sweep width was changed to an upper end potential of 0.7 V (vs Ag/AgCl) and a lower end potential of −1.3 V (vs Ag/AgCl). The potential width was changed by 0.01 V_{Ag/AgCl} at a time, and the total number of potential sweep cycles was set at 100 cycles. The deposit after the step 3 (after the potential sweep) is a deposit 3.

### Example 2

After the same steps 1 and 2 as in Example 1 were performed, a step 3 was performed in which the same treatment as in Example 1 was performed except that with the sweep rate set at 90 mV/s, gradually the potential sweep width was changed to an upper end potential of 0.475 V (vs Ag/AgCl) and a lower end potential of −1.175 V (vs Ag/AgCl) (the potential width was changed by 0.01 V_{Ag/AgCl} at a time, and the total number of potential sweep cycles was set at 100 cycles). The deposit after the step 3 in Example 2 is referred to as a deposit 3 (2).

### Example 3

A layered manganese oxide of the present invention was fabricated by the following steps 1 to 3.

(Step 1) 0.7089 g of 50 mM [CH₃ (CH₂)₃]₄NCl (TBACl) and 0.024 g of 2 mM MnSO₄·5H₂O were dissolved in distilled water to 50 mL. The obtained aqueous solution was bubbled with N₂ for 20 min to remove the oxygen in the solution. Electrochemical deposition was performed under the conditions of keeping 1.0 V, and 200 mC/cm², employing a salt bridge, with the reference electrode being Ag/AgCl, the counter electrode being a Pt mesh, and the working electrode being an FTO electrode, to deposit a deposit on the FTO electrode. The deposit after the step 1 is a deposit 1 (3).

(Step 2) After the deposit on the FTO electrode obtained in the step 1 was lightly washed with distilled water without being separated from the FTO electrode, the deposit on the FTO electrode was vacuum-dried at ordinary temperature for 1 h. After drying, the FTO electrode in a state in which the deposit adhered was immersed in a 50 mM Pd(NH₃)₄Cl₂ solution for 24 h to perform ion exchange. The deposit after the step 2 (after the ion exchange) is a deposit 2 (3).

(Step 3) A three-electrode cell employing for the working electrode the FTO electrode in the state in which the deposit adhered obtained in the step 2, a Pt wire for the counter electrode, and Ag/AgCl for the reference electrode was constructed. For the electrolytic solution, 0.1 M KOH in which N₂ was bubbled for 20 min was employed. A potential sweep was started using a potentiostat connected to the cell, with the potential of the working electrode set at −0.975 to 0.050 V (vs Ag/AgCl). At this time, the potential sweep start potential was set at −0.974 V (vs Ag/AgCl). With the sweep rate set at 50 mV/s, gradually the potential sweep width was changed to an upper end potential of 0.7 V (vs Ag/AgCl) and a lower end potential of −1.2 V (vs Ag/AgCl). The potential width was changed by 0.05 V_{Ag/Agcl} at a time, and the total number of potential sweep cycles was set at 30 cycles. The deposit after the step 3 (after the potential sweep) is a deposit 3 (3).

### Example 4

A layered manganese oxide of the present invention was fabricated by the following steps 1 to 3.

(Step 1) 0.7089 g of 50 mM [CH₃ (CH₂)₃]₄NCl (TBACl) and 0.024 g of 2 mM MnSO₄·5H₂O were dissolved in distilled water to 50 mL. The obtained aqueous solution was bubbled with N₂ for 20 min to remove the oxygen in the solution. Electrochemical deposition was performed under the conditions of keeping 1.0 V, and 200 mC/cm², employing a salt bridge, with the reference electrode being Ag/AgCl, the counter electrode being a Pt mesh, and the working electrode being a glassy carbon rotating disk electrode (GC electrode) having a diameter of 5 mm ground with polishing diamond and alumina, to deposit a deposit on the GC electrode. The deposit after the step 1 is a deposit 1.

(Step 2) After the deposit on the GC electrode obtained in the step 1 was lightly washed with distilled water without being separated from the GC electrode, the deposit on the GC electrode was vacuum-dried at ordinary temperature for 1 h. After drying, the GC electrode in a state in which the deposit adhered was immersed in a 50 mM Pt(NH₃)₄Cl₂ solution for 3 h to perform ion exchange. The deposit after the step 2 (after the ion exchange) is a deposit 2.

(Step 3) A three-electrode cell employing for the working electrode the GC electrode in the state in which the deposit adhered obtained in the step 2, a carbon rod for the counter electrode, and Ag/AgCl for the reference electrode was constructed. For the electrolytic solution, 0.05 M [CH₃(CH₂)₃]₄NOH (TBAOH) in which N₂ was bubbled for 20 min was employed. A potential sweep was started using a potentiostat connected to the cell, with the potential of the working electrode set at −0.1 to 1.5 V (vs RHE). With the sweep rate set at 10 mV/s, the potential sweep was performed for 40 h. The deposit after the step 3 (after the potential sweep) is a deposit 3 (4). −0.1 To 1.5 V (vs RHE) is −1.013 to 0.587 V (vs Ag/AgCl) when converted by the conversion formula “E (Ag/AgCl)=E (RHE)−0.059 pH−0.199”.

### Example 5

After the same steps 1 and 2 as in Example 4 were performed, a step 3 was performed in which the same treatment as in Example 4 was performed except that the sweep rate was set at 50 mV/s. The deposit after the step 3 in Example 5 is a deposit 3 (5).

### Example 6

After the same steps 1 and 2 as in Example 4 were performed, a step 3 was performed in which the same treatment as in Example 4 was performed except that the sweep rate was set at 150 mV/s. The deposit after the step 3 in Example 6 is a deposit 3 (6).

### Examples 7 to 10

Layered manganese oxides of the present invention were fabricated by the following steps 1 to 3.

(Step 1) 0.7089 g of 50 mM [CH₃(CH₂)₃]₄NCl (TBACl) and 0.024 g of 2 mM MnSO₄·5H₂O were dissolved in distilled water to 50 mL. The obtained aqueous solution was bubbled with N₂ for 20 min to remove the oxygen in the solution. Electrochemical deposition was performed under the conditions of keeping 1.0 V, and 200 mC/cm², employing a salt bridge, with the reference electrode being Ag/AgCl, the counter electrode being a Pt mesh, and the working electrode being a glassy carbon rotating disk electrode (GC electrode) having a diameter of 5 mm ground with polishing diamond and alumina, to deposit a deposit on the GC electrode. The deposit after the step 1 is a deposit 1.

(Step 2) After the deposit on the GC electrode obtained in the step 1 was lightly washed with distilled water without being separated from the GC electrode, the deposit on the GC electrode was vacuum-dried at ordinary temperature for 1 h. After drying, the GC electrode in a state in which the deposit adhered was immersed in a 50 mM Pt(NH₃)₄Cl₂ solution for 3 h to perform ion exchange. The deposit after the step 2 (after the ion exchange) is a deposit 2.

(Step 3) A three-electrode cell employing for the working electrode the GC electrode in the state in which the deposit adhered obtained in the step 2, a carbon rod for the counter electrode, and Ag/AgCl for the reference electrode was constructed. For the electrolytic solution, 0.1 M KOH in which N₂ was bubbled for 20 min was employed. A potential sweep was started using a potentiostat connected to the cell, with the potential of the working electrode set at 0.05 to 1.5 V (vs RHE). The potential sweep was performed with the number of sweep cycles set at 100 cycles, 94 cycles, 100 cycles, and 132 cycles respectively for sweep rates of 10 mV/s, 30 mV/s, 50 mV/s, and 150 mV/s, to provide Examples 7 to 10. The deposits after the step 3 (after the potential sweep) in Examples 7 to 10 were a deposit 3 (7), a deposit 3 (8), a deposit 3 (9), and a deposit 3 (10) respectively. 0.05 To 1.5 V (vs RHE) is −0.975 to 0.475 V (vs Ag/AgCl) when converted by the conversion formula “E (Ag/AgCl)=E (RHE)−0.059 pH−0.199”.

### Comparative Example 1

After the same steps 1 and 2 as in Example 1 were performed, a three-electrode cell having the same configuration as in Example 1 was used, and the potential of the working electrode was fixed at 0.475 V (vs Ag/AgCl) for 30 min.

### Comparative Example 2

After the same steps 1 and 2 as in Example 1 were performed, a three-electrode cell having the same configuration as in Example 1 was used, and the potential of the working electrode was fixed at −1.175 V (vs Ag/AgCl) for 30 min.

### X-Ray Diffraction Measurement

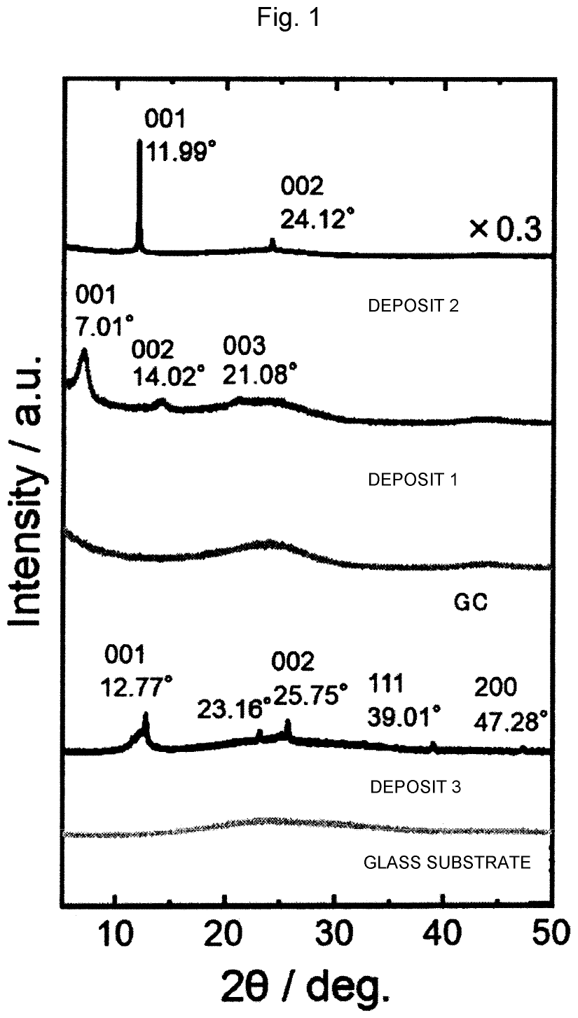

The deposits 1 to 3 of Example 1 were peeled from the GC electrodes, and X-ray diffraction measurement was performed on each (Cu-Ka radiation, Rigaku Ultima IV, manufactured by Rigaku Corporation). Furthermore, the X-ray diffraction measurement of GC and glass was performed. The obtained X-ray diffraction patterns are shown in FIG. 1. For all of the deposits 1 to 3, diffraction peaks at equal intervals specific to layered manganese dioxide were observed at 2θ=7°, 14°, and 21° (the deposit 1), 12° and 24° (the deposit 2), and 12.7°, 23.2°, and 25.8° (the deposit 3). Compared with the deposit 1, the peaks of MnO₂ in the deposits 2 and 3 shifted to the high angle side. This shows that the interlayer distance decreased while the structure was maintained. When the interlayer distances of the thin films were obtained from the diffracted X-ray peak angle positions θ and the X-ray wavelength λ (=1.54051 Å) by the Bragg condition (nλ=2d sin θ), they were 1.24 nm (the deposit 1) and 0.74 nm (the deposit 2). The latter corresponds to the sum of the NH₃ molecular diameter and the crystallographic thickness of the MnO₂ sheet (one layer) (0.45 nm). This is thought to be because TBA⁺ present between the layers of the deposit 1 was replaced by Pt(NH₃)₄²⁺ by the treatment of the step 2. As a result of similar computation, the interlayer distance of the deposit 3 was 0.69 nm. It is thought that the interlayer distance shortened by the step 3, and with this interlayer distance, NH₃ could not be present, and therefore NH₃ that was the ligand of Pt(NH₃)₄²⁺ was eliminated by the treatment of the step 3. Considering the MnO₂ sheet crystallographic thickness, the particle diameter of the Pt particles generated by the elimination of NH₃ can be estimated to be on the order of 0.24 nm. This is extremely close to a reported Pt monatomic diameter (about 0.27 nm), and it is thought that Pt single-atom particles were able to be synthesized. Diffraction peaks attributed to nanoparticles of Pt were confirmed around 39° and 47°, and therefore it is thought that in addition to the above-described Pt single-atom particles, Pt nanoparticles also coexist.

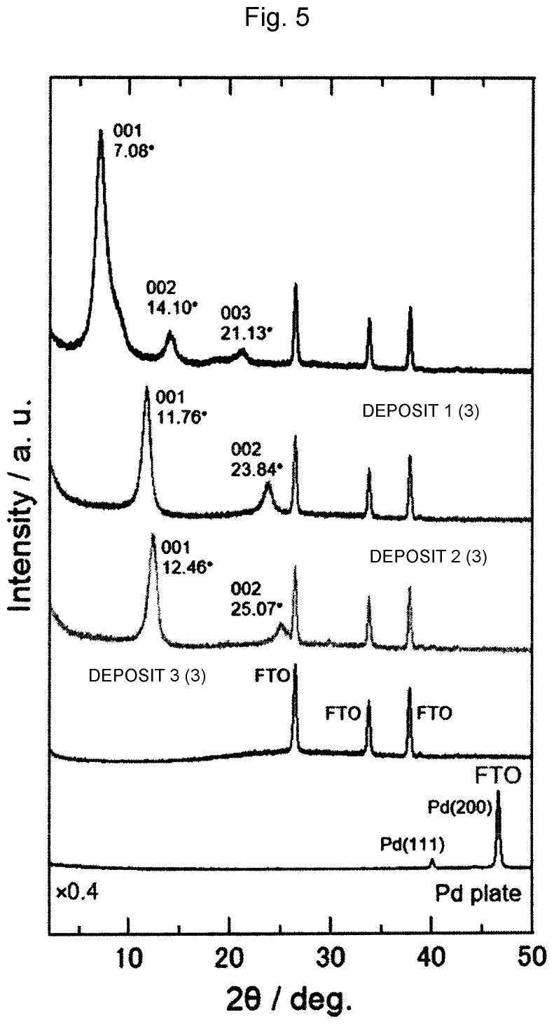

The FTO electrodes in the state in which the deposit adhered obtained in the steps 1 to 3 of Example 3 were each subjected to X-ray diffraction measurement (Cu-Ka radiation, Rigaku Ultima IV, manufactured by Rigaku Corporation). Furthermore, the X-ray diffraction measurement of FTO was performed. The obtained X-ray diffraction patterns are shown in FIG. 5. For all of the deposits 1 (3) to 3 (3), diffraction peaks at equal intervals specific to layered manganese dioxide were observed at 2θ=7°, 14°, and 21° (the deposit 1), 12° and 24° (the deposit 2), and 12.5° and 25.1° (the deposit 3). Compared with the deposit 1 (3), the peaks of MnO₂ in the deposits 2 (3) and 3 (3) shifted to the high angle side. This shows that the interlayer distance decreased while the structure was maintained. When the interlayer distances of the thin films were obtained from the diffracted X-ray peak angle positions θ and the X-ray wavelength λ (=1.54051 Å) by the Bragg condition (nλ=2d sin θ), they were 1.25 nm (the deposit 1) and 0.75 nm (the deposit 2). The latter corresponds to the sum of the NH₃ molecular diameter and the crystallographic thickness of the MnO₂ sheet (one layer) (0.45 nm). This is thought to be because TBA⁺ present between the layers of the deposit 1 was replaced by Pd(NH₃)₄²⁺ by the treatment of the step 2. As a result of similar computation, the interlayer distance of the deposit 3 was 0.71 nm. It is thought that the interlayer distance shortened by the step 3, and with this interlayer distance, NH₃ could not be present, and therefore NH₃ that was the ligand of Pd(NH₃)₄²⁺ was eliminated by the treatment of the step 3. Considering the MnO₂ sheet crystallographic thickness, the particle diameter of the Pd particles generated by the elimination of NH₃ can be estimated to be on the order of 0.26 nm. This is extremely close to a reported Pd monatomic diameter (about 0.27 nm), and it is thought that Pd single-atom particles were able to be synthesized. It is known that diffraction peaks attributed to nanoparticles of Pd are confirmed around 40° and 46°, but they were not confirmed this time. From this, it is thought that only the above-described Pd single-atom particles are present in the deposit 3.

### X-Ray Photoelectron Spectroscopy

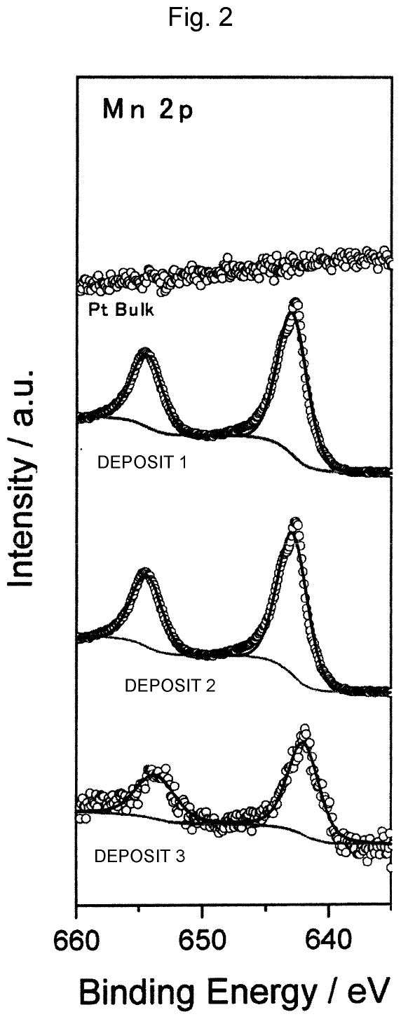

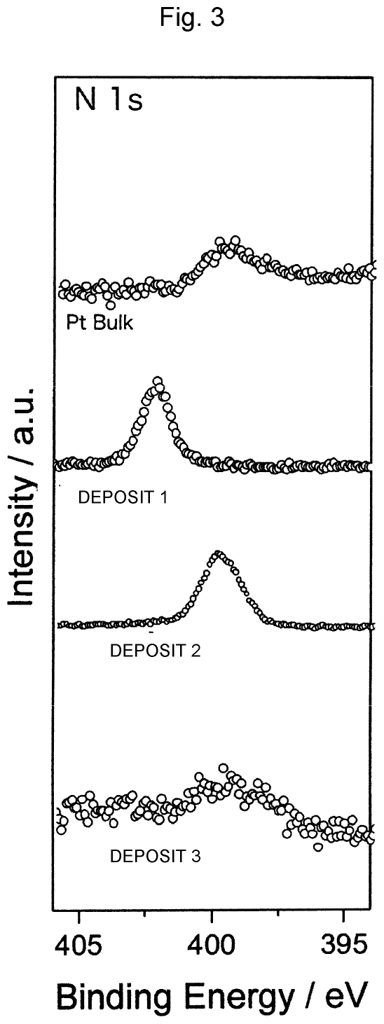

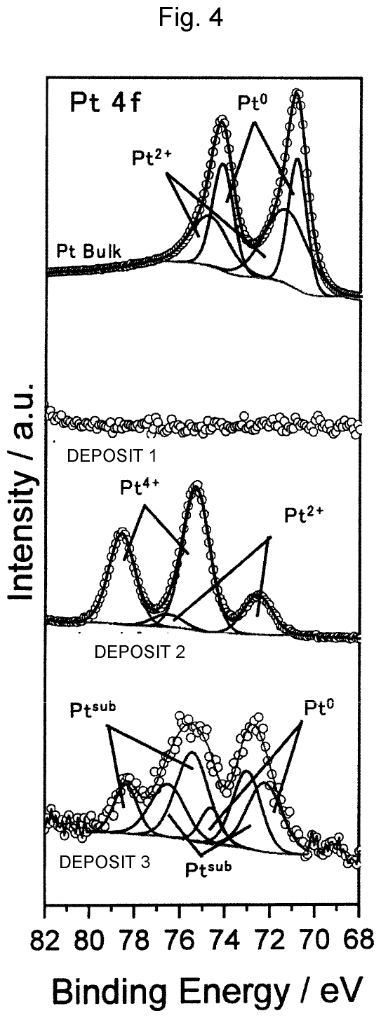

The deposits 1 to 3 of Example 1 were peeled from the GC electrodes, and X-ray photoelectron spectroscopy (XPS) was performed on each (K-Alpha, manufactured by Thermo Scientific). The results are shown in FIGS. 2 to 4. For the deposits 1 to 3, spectrum peaks were seen in the range of Mn 2p, and therefore the presence of Mn was confirmed (FIG. 2). For the deposit 1, a spectrum peak of a cationic N species was seen, and therefore it was confirmed that TBA⁺ was introduced (FIG. 3). For the deposit 2, the spectrum peak of the cationic N species disappeared, and a peak derived from NH₃ was seen (FIG. 3), and peaks of Pt²⁺ and Pt⁴⁺, which were not seen for the deposit 1, were seen in the range of Pt 4f (FIG. 4), and therefore it was confirmed that for the deposit 2, TBA⁺ was replaced by Pt(NH₃)₄²⁺, and Pt(NH₃)₄²⁺ was introduced. For the deposit 3, peaks of Pt⁰ derived from a Pt bulk, rather than peaks of Pt²⁺ and Pt⁴⁺, were seen. Furthermore, in addition to the peaks of Pt⁰ derived from the Pt bulk, two types of Pt 4f peaks were seen. Pt 4f peaks shift to the high energy side as its particle diameter decreases. Therefore, it is shown that Pt particles of a plurality of sizes are present in the deposit 3, and it is thought that in addition to aggregates of Pt, Pt particles having an extremely small size (written as Pt^{sub}) are generated. From the results of the X-ray diffraction measurement and the X-ray photoelectron spectroscopy, the deposit 1 was identified as TBA⁺/MnO₂, the deposit 2 was identified as Pt(NH₃)₄²⁺/MnO₂, and the deposit 3 was identified as Pt/MnO₂. When the mass ratio between MnO₂ and Pt in the deposit 3 was obtained from the proportion of the numbers of atoms according to the results of the XPS measurement, MnO₂:Pt was 1:0.45.

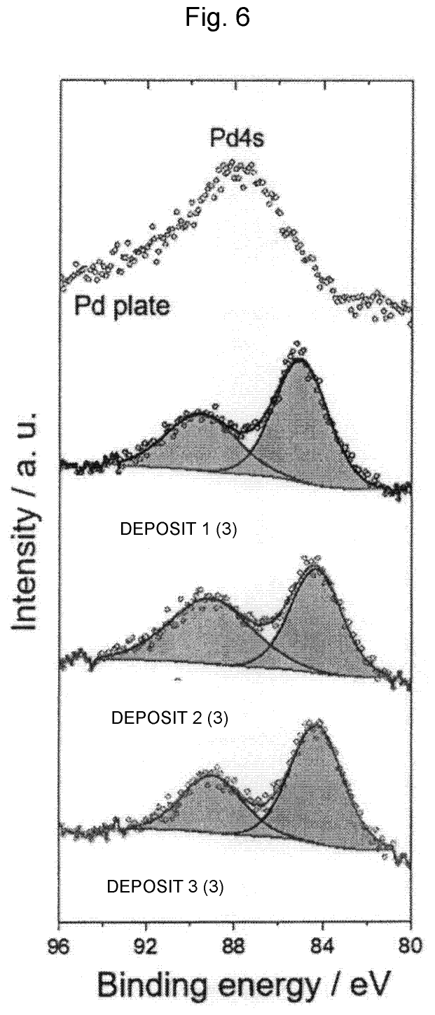

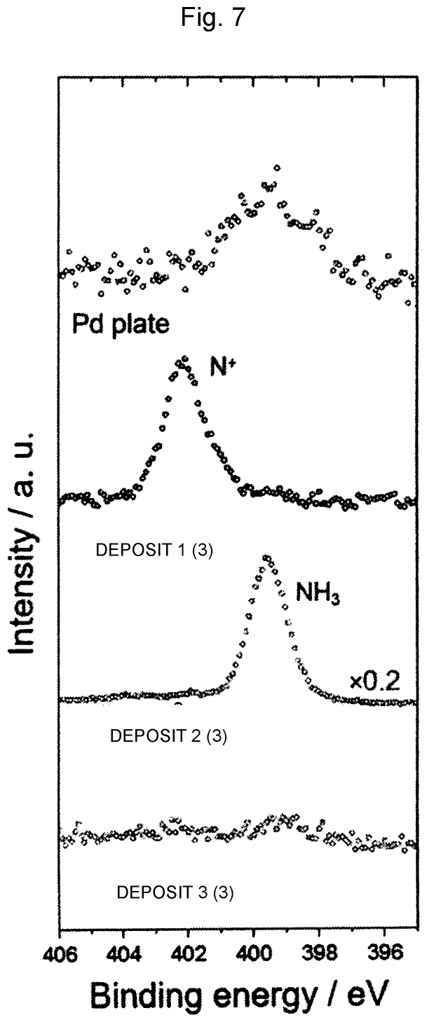

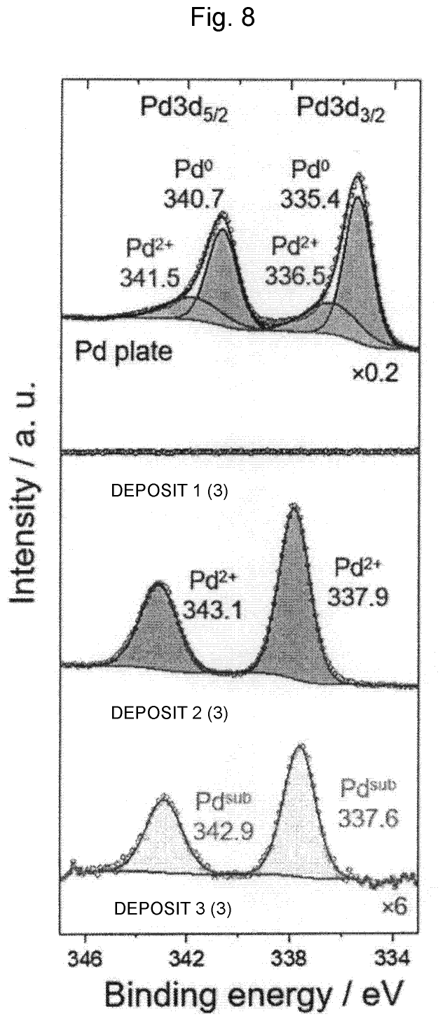

X-Ray photoelectron spectroscopy (XPS) was performed on each of the FTO electrodes in the state in which the deposit adhered obtained in the steps 1 to 3 of Example 3 (K-Alpha, manufactured by Thermo Scientific). The results are shown in FIGS. 6 to 8. For the deposits 1 (3) to 3 (3), spectrum peaks were seen in the range of Mn 2p, and therefore the presence of Mn was confirmed (FIG. 6). For the deposit 1 (3), a spectrum peak of a cationic N species was seen, and therefore it was confirmed that TBA⁺ was introduced (FIG. 7). For the deposit 2 (3), the spectrum peak of the cationic N species disappeared, and a peak derived from NH₃ was seen (FIG. 7), and peaks of Pd²⁺, which were not seen for the deposit 1, were seen in the range of Pd 3d (FIG. 8), and therefore it was confirmed that for the deposit 2 (3), TBA⁺ was replaced by Pd(NH₃)₄²⁺, and Pd(NH₃)₄²⁺ was introduced. For the deposit 3 (3), peaks of Pd⁰ derived from Pd particles having an extremely small size (written as Pd^{sub}), rather than peaks of Pd²⁺, were seen (FIG. 8). Here, Pd 3d peaks shift to the high energy side as its particle diameter decreases. Therefore, it is thought that Pd particles having an extremely small size (written as Pd^{sub}) are generated in the deposit 3. From the results of the X-ray diffraction measurement and the X-ray photoelectron spectroscopy, the deposit 1 (3) was identified as TBA⁺/MnO₂, the deposit 2 (3) was identified as Pd(NH₃)₄²⁺/MnO₂, and the deposit 3 (3) was identified as Pd/MnO₂. When the mass ratio between MnO₂ and Pd in the deposit 3 (3) was obtained from the proportion of the numbers of atoms according to the results of the XPS measurement, MnO₂:Pd was 1:0.07.

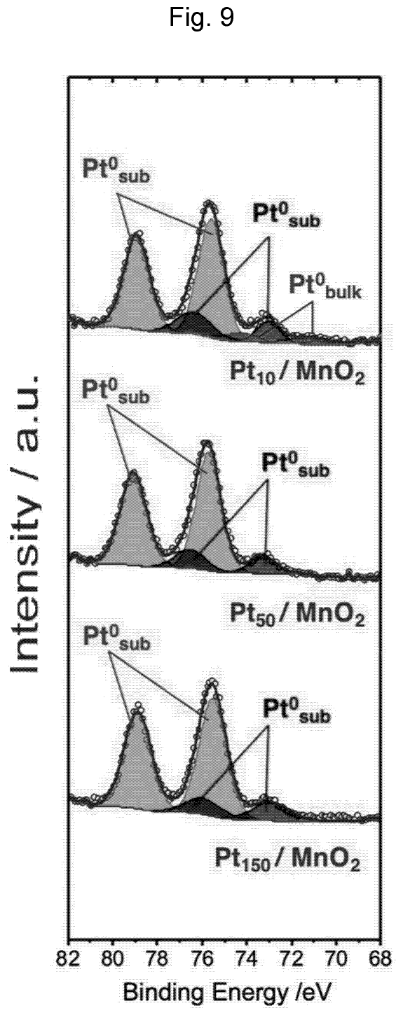

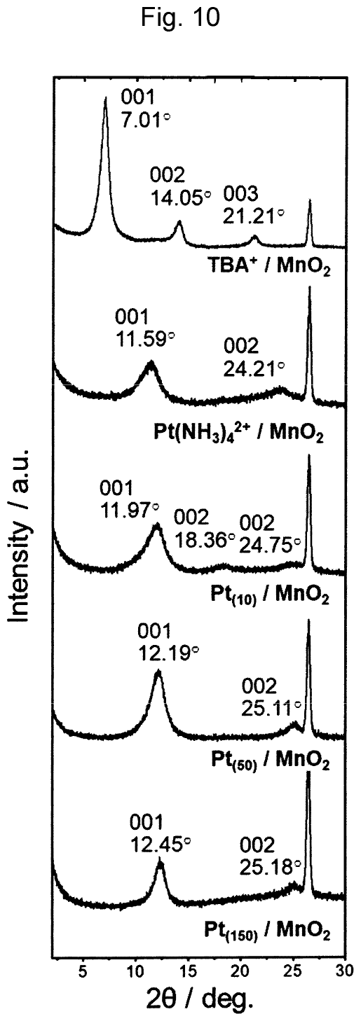

The deposits 3 (4) to 3 (6) of Examples 4 to 6 were peeled from the GC electrodes, and X-ray photoelectron spectroscopy (XPS) was performed on each (K-Alpha, manufactured by Thermo Scientific). The results are shown in FIG. 9. For the deposits 3 (4) to 3 (6), for the deposit 3 (4), in addition to peaks of Pt⁰ derived from a Pt bulk, two types of Pt 4f peaks (written as Pt^{sub}) were seen. For the deposits 3 (5) and 3 (6), no peaks of Pt⁰ derived from a Pt bulk were noted, and only the Pt 4f peaks of Pt^{sub} were seen. Furthermore, the deposits 1 and 2 of Example 4 and the deposits 3 (4) to 3 (6) of Examples 4 to 6 were peeled from the GC electrodes, and X-ray diffraction measurement was performed on each (Cu-Ka radiation, Rigaku Ultima IV, manufactured by Rigaku Corporation). The obtained X-ray diffraction patterns are shown in FIG. 10. The deposit 1, the deposit 2, the deposit 3 (4), the deposit 3 (5), and the deposit 3 (6) are shown in order from above in FIG. 10. In FIG. 9, Pt₁₀/MnO₂, Pt₅₀/MnO₂, and Pt₁₅₀/MnO₂ represent the deposit 3 (4), the deposit 3 (5), and the deposit 3 (6) respectively, and in FIG. 10, Pt₍₁₀₎/MnO₂, Pt(so)/MnO₂, and Pt₍₁₅₀₎/MnO₂ represent the deposit 3 (4), the deposit 3 (5), and the deposit 3 (6) respectively. Diffraction peaks at equal intervals specific to layered manganese dioxide were observed at 28=7°, 14°, and 21° derived from the diffraction of the (001) face, the (002) face, and the (003) face respectively for the deposit 1, and at 11.59° and 24.21° derived from the diffraction of the (001) face and the (002) face respectively for the deposit 2. Diffraction peaks at equal intervals specific to layered manganese dioxide, derived from the diffraction of the (001) face and the (002) face were observed at 28=11.97°, 18.36°, and 24.75° for the deposit 3 (4), at 12.19° and 25.11° for the deposit 3 (5), and at 12.45° and 25.18° for the deposit 3 (6), as shown in FIG. 10. When the interlayer distances of the thin films were obtained from the diffracted X-ray peak angle positions θ and the X-ray wavelength λ (=1.54051 Å) by the Bragg condition (nλ=2d sin θ), the interlayer distance was 0.72 nm and 0.96 nm for the deposit 3 (4), 0.73 nm for the deposit 3 (5), and 0.71 nm for the deposit 3 (6). For the deposit 3 (4), the diffraction peak of the (001) face (20=11.97°) was broad, and therefore the interlayer distance was calculated from the diffraction peaks of the (002) face (18.36° and 24.75°). In other cases, the interlayer distance was obtained from the diffraction peak of the (001) face. The particle diameter of the generated platinum particles calculated considering the crystallographic thickness of the MnO₂ sheet (layer) (0.45 nm) was 0.27 nm and 0.51 nm for the deposit 3 (4), 0.28 nm for the deposit 3 (5), and 0.26 nm for the deposit 3 (6). The calculated particle diameters 0.27 nm and 0.28 nm are extremely close to the Pt monatomic diameter (about 0.27 nm), and therefore it is deemed that the platinum particles are present as single-atom particles. In the case of the calculated particle diameter 0.51 nm (that is, when the gap between a layer and a layer is 0.51 nm), a case where platinum particles having a particle diameter of 0.51 nm are present, a case where platinum particles having a particle diameter of less than 0.51 nm are present overlapping (aggregating) partially, and a case where both of these are present are thought. From the results of FIGS. 9 and 10, it is found that layered manganese oxides possessing a structure in which platinum particles are stored between layers are obtained, and furthermore the particle diameter of the stored platinum particles changes depending on the sweep rate in the step 3.

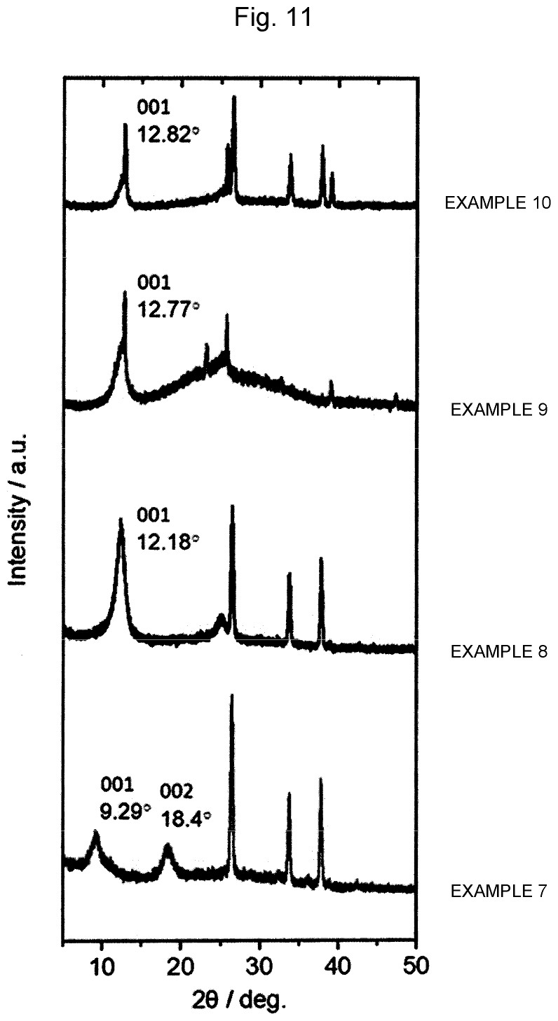

The deposits 3 (7) to 3 (10) of Examples 7 to 10 were peeled from the GC electrodes, and X-ray photoelectron spectroscopy (XPS) was performed on each (K-Alpha, manufactured by Thermo Scientific). The results are shown in FIG. 11. When the interlayer distances of the thin films were obtained from the diffracted X-ray peak angle positions θ and the X-ray wavelength λ (=1.54051 Å) by the Bragg condition (nλ=2d sin θ), the interlayer distance was 0.951 nm for the deposit 3 (7), 0.726 nm for the deposit 3 (8), 0.693 nm for the deposit 3 (9), and 0.690 nm for the deposit 3 (10). The particle diameter of the generated platinum particles calculated considering the MnO₂ sheet crystallographic thickness (0.45 nm) was 0.501 nm for the deposit 3 (7), 0.276 nm for the deposit 3 (8), 0.243 nm for the deposit 3 (9), and 0.240 nm for the deposit 3 (10). Also from these results, it is found that as the sweep rate becomes faster, the particle diameter of the synthesized platinum particles decreases, or the aggregation lessens.

### Cyclic Voltammetry

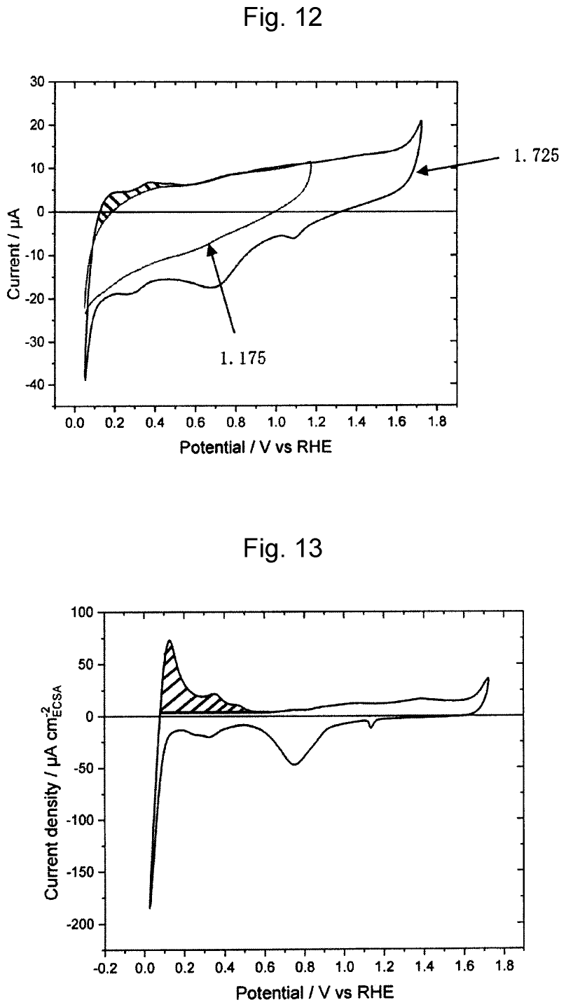

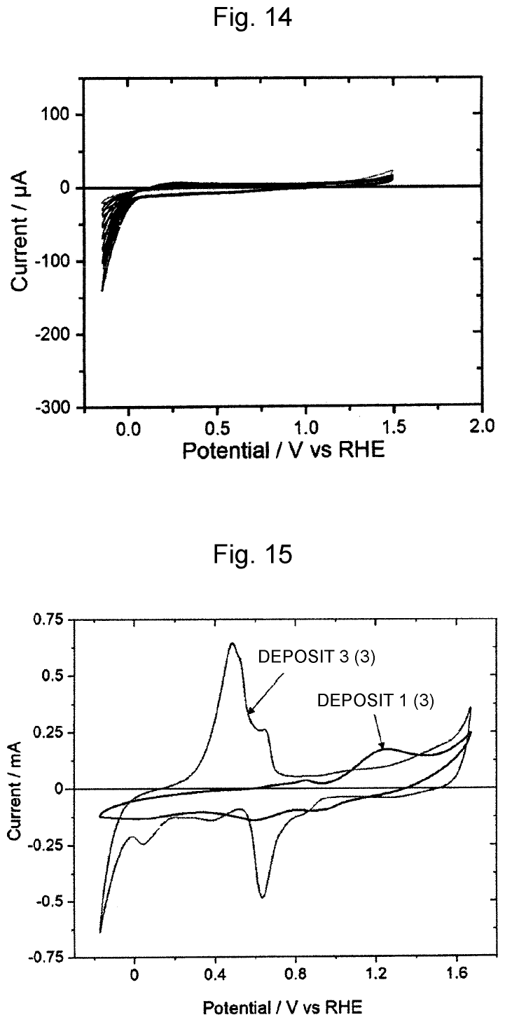

Cyclic voltammetry (CV) was performed employing as the working electrode each of the GC electrode obtained in the step 3 of Example 1 (a layer of the deposit 3 was formed on the surface) and a platinum electrode. For the counter electrode, a Pt wire was employed. For the reference electrode, Ag/AgCl was employed. For the electrolytic solution, 0.1 M KOH was employed. The temperature was set at 25° C. The results are shown in FIG. 12 and FIG. 13. For the GC electrode obtained in the step 3, the measurement was performed in the range of 0.05 to 1.725 V_{RHE} (sweep rate 50 mV/s) (FIG. 12). For the platinum electrode, the measurement was performed in the range of 0.05 to 1.725 V_{RHE} (sweep rate 50 mV/s) (FIG. 13). FIG. 12 also shows the results of performing CV in the range of 0.05 to 1.175 V_{RE} for the GC electrode obtained in the step 2 of Example 1. Oxidation-reduction peaks specific to Pt were able to be confirmed for the deposit 3, and thus the presence of electrochemically active Pt between the layers of Pt/MnO₂ was shown. The hatched portions in FIGS. 12 and 13 each represent the total amount of electricity due to hydrogen elimination. When the amount of electricity obtained from the hatched portion was divided by the amount of electricity of hydrogen desorption per unit platinum surface area, 210 μC/cm², to seek the active surface area (ECSA), it was 0.085 cm² for the GC electrode obtained in the step 3. Then, the measurement was performed in the range of −0.15 to 1.5 V_{RHE} (sweep rate 90 mV/s) by a method similar to the above using the GC electrode obtained in the step 3 of Example 2 (a layer of the deposit 3 (2) was formed on the surface). The results are shown in FIG. 14. From FIG. 14, an increase in reduction current derived from hydrogen evolution reaction was confirmed in the region of 0 V or less, and the metalation of Pt by the repetition of the cycle was able to be confirmed.

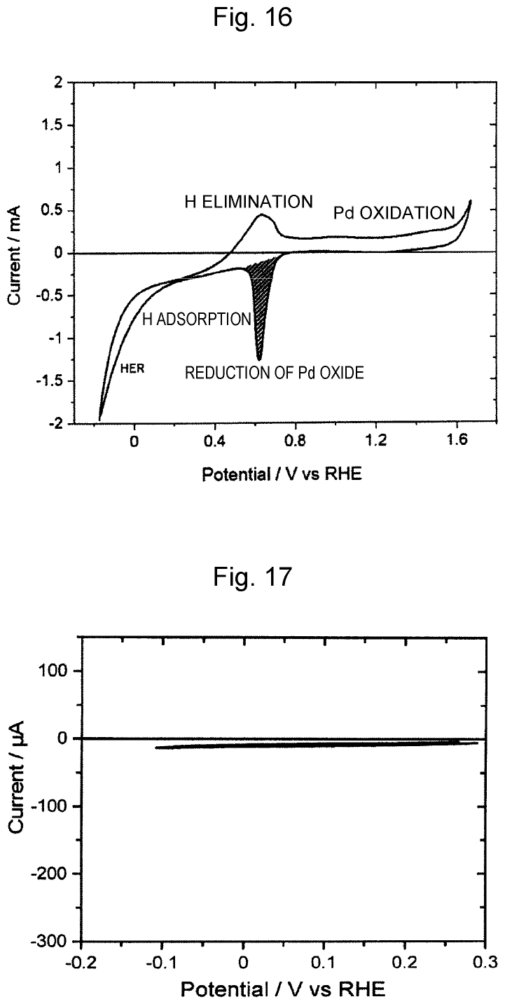

Cyclic voltammetry (CV) was performed employing as the working electrode each of the FTO electrodes obtained in the steps 1 and 3 of Example 3 (a layer of the deposit 1 (3) or 3 (3) was formed on the surface) and a Pd electrode. For the counter electrode, a Pt wire was employed. For the reference electrode, Ag/AgCl was employed. For the electrolytic solution, 0.1 M KOH was employed. The results are shown in FIGS. 15 and 16. For the FTO electrodes obtained in the step 1 and the step 3, the measurement was performed in the range of −0.175 to 1.725 V_{R}M (sweep rate 50 mV/s) (FIG. 15). For the Pd electrode, the measurement was performed in the range of −0.175 to 1.725 V_{RHE} (sweep rate 50 mV/s) (FIG. 16). Oxidation-reduction peaks specific to Pd were able to be confirmed for the deposit 3 (3), and thus the presence of electrochemically active Pd between the layers of Pd/MnO₂ was shown. The hatched portion in FIG. 16 represents the total amount of electricity due to PdO reduction. When the active surface area (ECSA) was roughly estimated from the amount of electricity obtained from the area of a peak at a similar position in FIG. 15, the ECSA of the FTO electrode obtained in the step 3 was 0.076 cm².

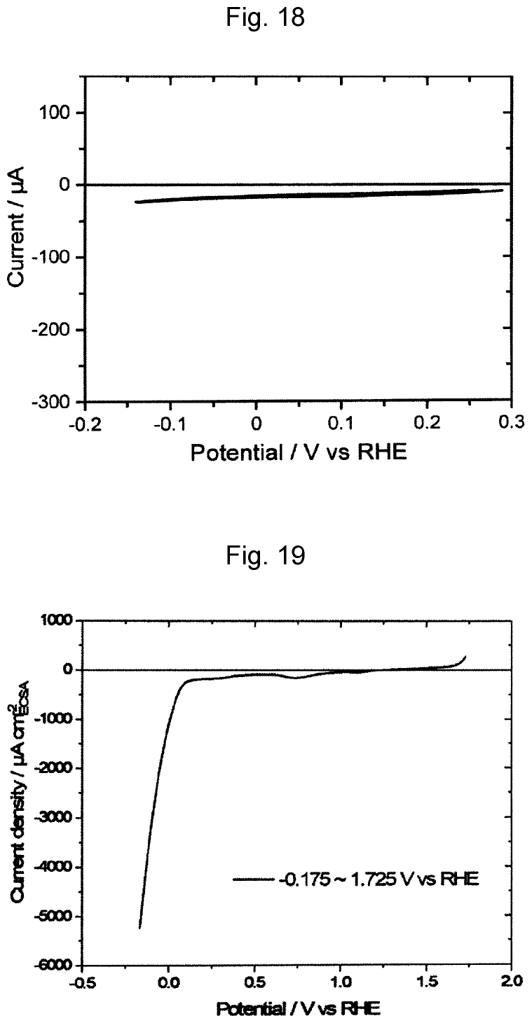

Measurement was performed in the range of −0.11 to 0.3 V_{RHE} (sweep rate 90 mV/s) for Comparative Example 1 and in the range of −0.15 to 0.3 V_{RHE} (sweep rate 90 mV/s) for Comparative Example 2 by a method similar to that in the case of Example 1 using the GC electrodes obtained in Comparative Examples 1 and 2. The results of Comparative Example 1 are shown in FIG. 17, and the results of Comparative Example 2 are shown in FIG. 18. From FIGS. 17 and 18, reduction current derived from hydrogen evolution reaction could hardly be confirmed even in the region of 0 V or less. Thus, it is found that in Comparative Examples 1 and 2 in which a constant potential was kept, Pt was not metalated.

### Hydrogen Evolution Reaction

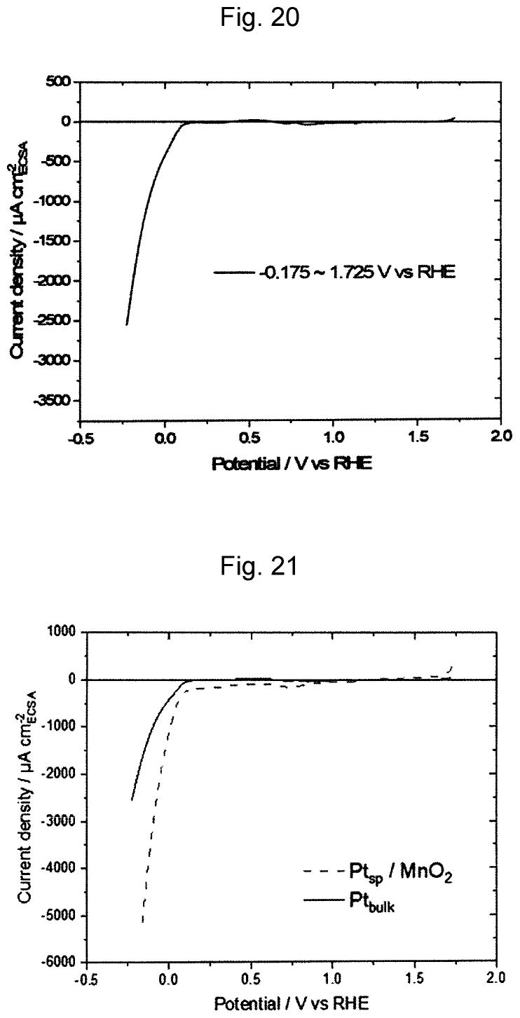

In order to evaluate activity for hydrogen evolution reaction (HER), linear sweep voltammetry (LSV) was performed in the range of −0.175 to 1.725 V_{RHE} (sweep rate 50 mV/s) employing as the working electrode each of the GC electrode obtained in the step 3 of Example 1 (a layer of the deposit 3 was formed on the surface) and a platinum electrode. For the counter electrode, a Pt wire was employed. For the reference electrode, Ag/AgCl was employed. For the electrolytic solution, 0.1 M KOH was employed. The current values were standardized by calculated ECSA. The results are shown in FIGS. 19 to 21. FIG. 19 shows the results of the GC electrode obtained in the step 3 of Example 1, FIG. 20 shows the results of the platinum electrode, and FIG. 21 is a diagram showing superimposed FIGS. 19 and 20. The HER start potential was 0.0942 V_{RHE} for the GC electrode obtained in the step 3, and 0.114 V_{RHE} for the platinum electrode, and therefore the start of HER was earlier for the GC electrode obtained in the step 3. Therefore, HER activity improvement was shown.

Linear sweep voltammetry (LSV) was performed in the range of −0.1 to 0.2 V_{RHE} (sweep rate 50 mV/s) employing as the working electrode the GC electrodes obtained in the step 3 of Examples 4 to 6 (a layer of the deposit 3 was formed on the surface). For the counter electrode, a carbon rod was employed. For the reference electrode, Ag/AgCl was employed. For the electrolytic solution, 0.1 M KOH was employed. The results are shown in FIG. 23. Pt₁₀/MnO₂, Pt₅₀/MnO₂, and Pt₁₅₀/MnO₂ in FIG. 23 represent the deposit 3 (4) of Example 4, the deposit 3 (5) of Example 5, and the deposit 3 (6) of Example 6 respectively. In the results in FIG. 23, the deposit 3 (4), the deposit 3 (5), and the deposit 3 (6) all showed HER activity, but the deposit 3 (4) and the deposit 3 (5) showed equivalent HER activity, whereas the HER activity of the deposit 3 (6) was low compared with these. From this, it is found that the HER activity can be adjusted by adjusting the sweep rate when performing reduction by electrolysis in the step 3.

### Oxygen Reduction Reaction

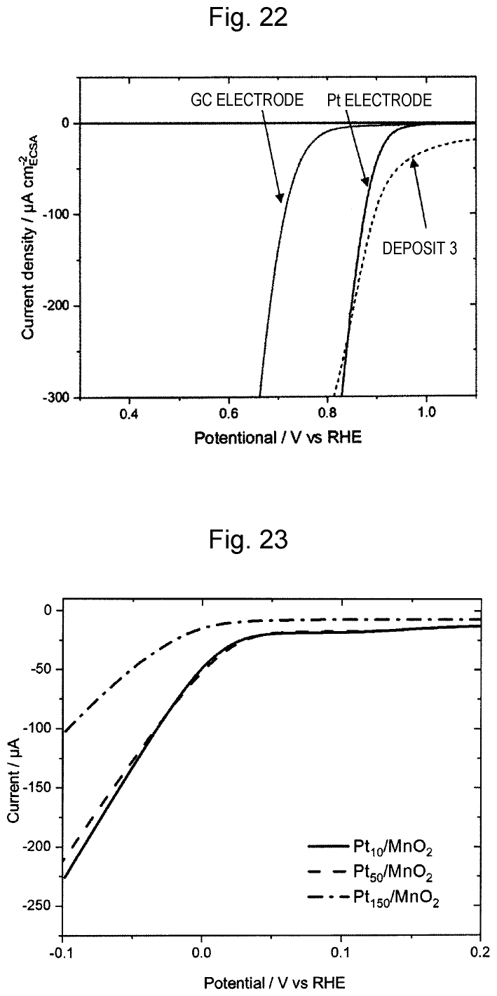

In order to evaluate activity for oxygen reduction reaction (ORR), linear sweep voltammetry (LSV) was performed in the range of 1.50 to 0.05 V_{RHE} employing as the working electrode each of the GC electrode obtained in the step 3 of Example 1 (a layer of the deposit 3 was formed on the surface), a GC electrode in which no deposit was deposited on the surface, and a platinum electrode. The sweep rate was set at 10 mV/s, and the number of revolutions was set at 4000 rpm in order to get rid of oxygen bubbles on the working electrode. For the counter electrode, a Pt wire was employed. For the reference electrode, Ag/AgCl was employed. For the electrolytic solution, 0.1 M KOH was employed. The current values were standardized by calculated ECSA. The results are shown in FIG. 22. The start of ORR was earlier for the GC electrode obtained in the step 3 than for the platinum electrode, and it was confirmed that the ORR activity improved.

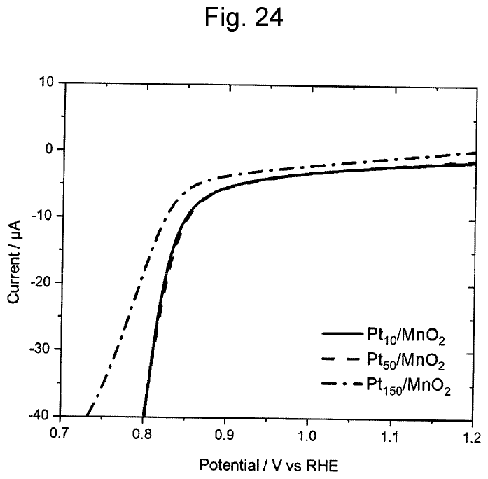

Linear sweep voltammetry (LSV) was performed in the range of 0.7 to 1.2 V_{RHE} employing as the working electrode the GC electrodes obtained in the step 3 of Examples 4 to 6 (a layer of the deposit 3 was formed on the surface). The sweep rate was set at 10 mV/s, and the number of revolutions was set at 4000 rpm in order to get rid of oxygen bubbles on the working electrode. For the counter electrode, a Pt wire was employed. For the reference electrode, Ag/AgCl was employed. For the electrolytic solution, 0.1 M KOH was employed. The results are shown in FIG. 24. Pt₁₀/MnO₂, Pt₅₀/MnO₂, and Pt₁₅₀/MnO₂ in FIG. 24 represent the deposit 3 (4) of Example 4, the deposit 3 (5) of Example 5, and the deposit 3 (6) of Example 6 respectively. In the results in FIG. 24, the deposit 3 (4), the deposit 3 (5), and the deposit 3 (6) all showed ORR activity, but the deposit 3 (4) and the deposit 3 (5) showed equivalent ORR activity, whereas the ORR activity of the deposit 3 (6) was low compared with these. From this, it is found that the ORR activity can be adjusted by adjusting the sweep rate when performing reduction by electrolysis in the step 3.

### INDUSTRIAL APPLICABILITY

The layered manganese oxide of the present invention is excellent in catalytic activity and therefore can be suitably used as a catalyst for oxygen reduction reaction, hydrogen evolution reaction, and the like. The production method of the present invention can produce platinum group particles of subnanosize or single-atom size and a layered manganese oxide comprising the platinum group particles between layers, and therefore can be suitably utilized for the production of a catalyst for oxygen reduction reaction, hydrogen evolution reaction, and the like excellent in catalytic activity.

1. A layered manganese oxide comprising platinum group metal particles between layers.

2. The layered manganese oxide according to claim 1, wherein a particle diameter of the platinum group metal particles is an atomic diameter of the platinum group to 0.7 nm.

3. The layered manganese oxide according to claim 2, wherein the particle diameter of the platinum group metal particles is a particle diameter obtained by subtracting, from an interlayer distance of the layered manganese oxide obtained by X-ray diffraction measurement, 0.45 nm, which is a crystallographic thickness of a layer included in the interlayer distance.

4. The layered manganese oxide according to claim 1, wherein a size of a gap between a layer and a layer in the layered manganese oxide is an atomic diameter of a platinum group to 1 nm.

5. An electrode comprising the layered manganese oxide according to claim 1 on a surface.

6. A method for producing a layered manganese oxide comprising platinum group metal particles between layers, or platinum group metal particles, the method comprising introducing a platinum group complex between layers of a layered manganese oxide and reducing the introduced platinum group complex by electrolysis, wherein a potential applied to the platinum group complex is changed in a positive direction and a negative direction.

7. The method according to claim 6, comprising forming, on a surface of an electrode, a layered manganese oxide in which a platinum group complex is introduced between layers, wherein a potential of the electrode is changed in a positive direction and a negative direction.

8. An electrode comprising the layered manganese oxide according to claim 2 on a surface.

9. An electrode comprising the layered manganese oxide according to claim 3 on a surface.

10. An electrode comprising the layered manganese oxide according to claim 4 on a surface.
